(19) United States
(12) Patent Application Publication
(10) Pub. No.: US 2004/0176250 A1
(43) Pub. Date: Sep. 9, 2004

(54) Elicitor made from trigonella foenum graecum seed extracts and use thereof in controlling pathogenics organisms of plants

(76) Inventors: Christelle Martinez, Port La Nouvelle (FR); Jean Claude Baccou, Montpellier Cedex (FR); Lucien Delpech, Port La Nouvelle (FR); Michel Delrieux, Port La Nouvelle (FR); Henri Cassan, Narbonne (FR)

Correspondence Address: YOUNG & THOMPSON, 745 SOUTH 23RD STREET 2ND FLOOR, ARLINGTON, VA, 22202

(21) Appl. No.: 10/480,482

(22) PCT Filed: Jun. 14, 2002
(86) PCT No.: PCT/FR02/02056

(30) Foreign Application Priority Data
Jun. 15, 2001 (FR) 0107898

(51) Int. Cl. A01N 63/00; A01N 65/00

(52) U.S. Cl. 504/117; 424/757

(57) ABSTRACT

The invention relates to a method for controlling pathogenic organisms of agronomically useful plants by means of a novel elicitor and to a composition for implementing said method. Said method for controlling pathogenic organisms of agronomically useful or ornamental plants is essentially characterized in that a novel elicitor contained in the seed extracts of Trigonella foenum graccum is applied to said plants. Said elicitor is applied in the precocious or mature growth states.

### FIELD OF THE INVENTION

The present invention relates to a process for combating pathogenic agents and all sorts of plant parasites (fungus, bacteria, virus, insects . . . etc . . . ) with the help of a new stimulator of the natural defenses of the plants or eliciter and composition for practicing this process. The new composition is active for prevention and curing and comprises an extract from seeds of fenugreek or Trigonella foenum graecum.

### PRIOR ART

Plants are continuously subject to parasitic pressure on the part of numerous pathogenic agents such as virus, bacteria, fungi or insects. The resistance of a plant to a pathogenic agent results either from the recognition of the pathogenic agent by the plant (gene for gene relation), or the stimulation of the defenses under the influence of damage caused by the parasite.

In the first case, the resistance results from the recognition of the pathogenic agent carrying a particular gene called “avirulence gene” by the plant provided with a corresponding “resistance gene”. In this case, there exists a real programmed genetically interactive relationship between the plant and the parasite. After recognition of the two protagonists, specific mechanisms are thus developed by the plant (metabolic cascade of events, synthesis or messenger signals or the resistance), giving it the characteristic of resistance, whilst the invasion of the host tissues by the pathogenic agent remains very localized.

In the second case, the defense mechanisms are induced, either by fungal attack for example, by oligosaccharides, emanating on the one hand from the degradation of the fungus walls under the action of hydrolases of the host, and on the other hand of the hydrolyzed cell walls by the enzymes of the fungus. This wall debris serves equally as messengers of the resistance.

Following a first triggering of the resistance mechanisms, the vegetables can develop increased resistance in the face of new parasitic attacks, particularly in the uninfected portions of the plant, and this again thanks to certain “natural chemical messengers”. This mechanism is called “Acquired Systemic Resistance”.

When a plant is sensitive to a pathogenic agent, the latter is incapable of recognizing its aggressor, either by the gene for gene relationship, or by the damaging effect. The latter is thus incapable of activating in an effective way its defense genes. It is thus possible to stimulate the natural defenses of the plants by providing them exogenously with these “natural chemical signals” of the resistance that they are incapable of producing in certain cases as to certain pathogenic agents.

When there is recognition between the plant and the pathogenic agent, particular mechanisms are developed by the plant. Often the plant responds by the appearance of cellular necrosis at the site of the attack by the pathogenic agent and thus blocks its progress. This defense reaction is almost always associated with occurrence of a mechanism such as phytalexine biosynthesis (antifungal molecules), defense enzymes such as peroxydases or proteins in combination with pathogenesis (PR proteins) such as chitinases or β-1,4-endoglucanases. These enzymes are capable of lysing the fungal and bacterial walls. When there is resistance, the plants are capable of reinforcing the cellular walls (synthesis of lignin) to block the pathogenic agent at its site of penetration.

There is known a process for the stimulation of the natural defenses of agronomically useful plants, which comprises the application to said plants of an eliciter or sensibilizing agent which is capable of in contact with the plants to give rise preventatively in the latter to the activation of defense genes at the site of application of the product as well as an acquired systemic resistance. Such a process is more particularly described in French patent application filed Jul. 18, 1997 under U.S. Pat. No. 2,766,059 filed by the GOEMAR Laboratories. This process uses an effective quantity of an oligo β-1-3-glucane. The latter is prepared from β-1-3-glucanes of various origins which are hydrolyzed to oligo β-1-3-glucanes. The β-1-3-glucanes derive from bacteria, particularly Alcaligenes faecalis, from fungi, particularly Schizophyllum and Sclerotium glucanium, from yeast, particularly Saccharomyces cerevisae, from algae and from cereals.

However, this process does not permit causing resistance several times in the same plant. A single spraying is possible. This process is thus essentially preventative and limited as to time.

There is described in U.S. Pat. No. 5,977,060, issued Nov. 2, 1999 to EDEN Bioscience, a process for combating insects on plants. In this patent, there are given numerous references concerning the eliciters for defensive systems of the plants against insects they may encounter. This process is a process for combating insects for plants, which consists in applying a polypeptide or protein eliciter to a plant or a seed under effective conditions to guard against insects. The eliciter (polypeptide or protein) causing the hypersensitive response, corresponds to the one obtained from a pathogenic agent selected from the group constituted by Erwinia, Pseudomonas, Xanthomonas, Phyrophtora and their mixtures. In one embodiment, the eliciter can be applied to the plants by applying a bacteria containing genes capable of secreting or exuding the polypeptide or the protein. The bacteria does not cause the illness and has been transformed (for example in a recombinant manner) by the genes encoding a polypeptide or a protein eliciting a hypersensitive response. This document thus describes a process for combating insects but not all pathogenic agents. Moreover, this document makes reference to genetic manipulations which are very poorly perceived by the public.

There are moreover known seeds of fenugreek which are used in the agrofood industry as spices and in the pharmaceutical industry. Fenugreek or Trigonella foenum graecum or else senegrain is a legume of the family papilionacae. Fenugreek contains an essential oil constituted by 40 different compounds of which 3-hydroxy4,5-dimethyl-oxolane-2-one seems to be the most important aromatic component. Among the non-volatile components that it contains, there have been identified furostanol glycosides and sterol and steroidic saponines (having a potential interest for the pharmaceutical industry).

There is described in U.S. Pat. No. 5,997,877, issued Dec. 7, 1999 to Emerald Seed Products Ltd., a process for extraction of commercially valuable fractions from seeds of fenugreek. The seeds of fenugreek contain a yellow central core, which is cotyledon and the white and semi-transparent endosperm surrounds the germ, and the tegument. This endosperm contains galatomannane gums and is surrounded by a dark brown cortex. The process of recovering gums or oleoresins consists in moistening the grains of fenugreek to a range of 14% to 20% humidity; crushing the grains of fenugreek; mixing the crushed seeds with a solvent for a contact period at a certain temperature so that certain components of the seeds will be absorbed by the solvent; separating the extract from the solvent. This process has the drawback of using a solvent which is a polar alcohol. Another process is described in U.S. Pat. No. 5,997,877, which consists in recovering the soluble fibers. To this end, the seeds are crushed, they are screened and the heavy part is recovered constituted by the tegument and by the mucilage (envelope). This heavy portion is then treated with hot water, which permits recovering the soluble fibers. The gums located in the light portion are then recovered with the help of a solvent.

The state of the art such as the patent DE 197 266, EP 0 493 670 or DATABASE references Nos. 1994-84121, XP 002194376 or Chemical Abstracts, Vol. 119, No. 11 (1993-913), KRASTA, make reference to the use of trigoneline alone, the molecule having been isolated and purified with solvent products that may be toxic.

### SUMMARY OF THE INVENTION

The present invention has for its object to counter pathogenic agents and all sorts of plant parasites (fungus, virus, bacteria, insects . . . etc . . . ) with the help of a new eliciting product, this latter permitting a preventive and also curative action.

The present invention relates moreover to a new eliciter which can comprise several eliciting molecules.

Still another object of the present invention is to provide a process for preparation of a new eliciter, this process being non-aggressive with regard to the environment.

The inventors of the present application have discovered, after laboratory tests, that extracts of fenugreek have the property of strongly stimulating different enzymatic activities involved in defense mechanisms of vegetation against pathogenic agents and all sorts of plant parasites (fungus, bacteria, virus, insects . . . etc . . . ).

The present invention thus relates to a process using as eliciter one or several molecules from extracts of Trigonella foenum graecum seed, these molecules having been subjected to no purification and isolation process and no treatment by solvents, which can give rise to toxic effects for the plants to be treated.

To this end, the process according to the invention for combating pathogenic agents of agronomically useful plants with the use of an eliciter product, is characterized essentially in that the eliciter product comprises an eliciting molecule from extracts of seeds of Trigonella foenum graecum.

The process according to the invention is moreover characterized in that the application is carried out in the precocious and/or adult vegetative stages.

Another characteristic of the process according to the invention is that the application is carried out as often as necessary with for example a frequency of application of 10 days or 15 days as is currently practiced in agriculture. The plants can bear the repetition of the treatments by the eliciter and the defense mechanisms of the plant are stimulated with each treatment.

The extract of seeds of Trigonella foenum graecum is obtained by a process consisting in crushing the seeds, separating the cotyledon and germ fraction, from the tegument and mucilage fraction, mixing the cotyledon and germ fraction with water, and carrying out the extraction of the components of the active eliciter with the water at a moderate temperature, with agitation.

The extraction is carried out preferably in a composition containing 10% by weight of cotyledon fraction and germ and 90% by weight of water. The extraction temperature is preferably in the range of ambient temperature (about 25°) to about 100° C.

Tests carried out have demonstrated that the eliciter product should comprise at least two eliciter molecules of different size. It is has been determined that a single molecule of a size greater than 30,000 Dalton or of a size less than 30,000 Dalton has very reduced effects and that the association of two molecules of which one is greater than 30,000 Dalton and one lower than this size gave very interesting results.

The present invention will now be described in greater detail with the help of the following examples, which are in no way limiting in the scope of the present invention.

### EXAMPLES

Example 1

### Process for Extraction of the New Eliciter

There are used seeds of fenugreek which are crushed so as to obtain a powder. The cotyledon and germ fraction are separated from the tegument and mucilage fraction by a densitometric process. There are mixed 100 grams of the cotyledon and germ fraction with 1000 ml of water, and the extraction is carried out at a temperature comprised between ambient temperature and 100° C., with slow agitation. Then the product is filtered with a filter having pores having a dimension between preferably 2 μm and 500 μm.

After these phases of mechanical separation of the cotyledon and germ fraction and the aqueous treatment with filtration, it seems interesting to introduce a dehydration phase by any known process and means (spraying, lyophilization, or evaporation for example) which has the effect of preventing the initially moist product from degrading or to avoid having recourse to stabilizing and preservative products.

Example 2

### Treatment of Garden and Ornamental Plants with Fenugreek Extract

The extract prepared in Example 1 above is sprayed on the following plants, and the resistance of different plants to different parasites is tested. By way of example, there are obtained very significant effects during preventive and curative treatments on: melon/oidium; melon/bacteriose; melon/Thrips; melon/aleurodes; grapevine/oidium; grapevine/mildew . . . etc . . .

These treated plants are compared with untreated plants. In the case of preventive treatment, the treated plants are less or not attacked by parasites (contrary to the untreated plants), if the treatment is regularly repeated. In the case of curative treatment, the treated plants see the symptoms of the infections decrease at the beginning of several days after the first treatment with fenugreek extract. The treatment can take place on young plants, on cuttings or on adult plants, in fact no matter what the vegetative stage of the plants.

There has also been observed an anti-insect effect of the treatment according to the invention.

1. Process for combating pathogenic agents of agronomically useful plants with the use of an eliciter product, characterized in that the eliciter product comprises at least one eliciter molecule of extracts of seeds of Trigonella foenum graecum.

2. Process according to claim 1, characterized in that the application is carried out in the young vegetative stage and/or in the adult vegetative stage.

3. Process according to claim 1, characterized in that the eliciter extract has the effect of combating pathogenic agents and all sorts of parasites of plants when it is used preventively against the infection of plants, and in a curative way.

4. Process according to claim 1 or 2, characterized in that the application is carried out at repeated time intervals, as often as necessary, for example every 10 days or 15 days. The plants bear the repetition of the treatments by the eliciter and the defense mechanisms are stimulated on each treatment.

5. New eliciter for practicing the process according to claims 2, 3 and 4, characterized in that it comprises at least one eliciter molecule from extracts of seeds of Trigonella foenum graecum.

6. New eliciter according to claim 5 characterized in that it is constituted by an extract of seeds of Trigonella foenum graecum comprising at least two eliciting molecules of which one is greater than 30,000 Dalton and the other less than 30,000 Dalton.

7. Process for preparation of the new eliciter according to claim 6, consisting in crushing the seeds, separating the cotyledon and germ fraction from the tegument and mucilage fraction, mixing the cotyledon and germ fraction with water, and carrying out the extraction of the components of the active eliciter with the water at a moderate temperature, with agitation.

8. Process according to claim 7, characterized in that the extraction is carried out preferably in a composition containing 10% by weight of cotyledon and endosperm fraction and 90% by weight of water. The extraction temperature is preferably in the range of ambient temperature (about 25° C.) to about 100° C.

9. Process according to claims 7 and 8 characterized in that after the separation phase of the cotyledon and germ fraction, its aqueous treatment and extraction, the eliciter product is dehydrated.
